(19) United States
(12) Patent Application Publication
(10) Pub. No.: US 2006/0112861 A1
(43) Pub. Date: Jun. 1, 2006

(54) Method of using wastewater sludge in the production of concrete

(76) Inventor: John Gerard Cronin, County Cork (IE)

Correspondence Address: JACOBSON HOLMAN PLLC, 400 SEVENTH STREET N.W., SUITE 600, WASHINGTON, DC, 20004, US

(21) Appl. No.: 10/532,599

(22) PCT Filed: Oct. 24, 2003
(86) PCT No.: PCT/IE03/00147

§ 371 Date: Dec. 7, 2005

(30) Foreign Application Priority Data
Oct. 24, 2002 (IE) 20020831

(51) Int. Cl. C04B 18/18

(52) U.S. Cl. 106/697

(57) ABSTRACT

A method of using wastewater sludge in the production of concrete comprising mixing cement, aggregate and wastewater sludge to form a concrete mix in which the additional step is carried out of mixing the wastewater sludge with an alkaline solution to achieve a wastewater sludge and alkaline solution mixture having a pH equal to or in excess of 11.5 prior to mixing with the aggregate and cement. Such a method is a simple and efficient method of producing ready usable concrete and will not require expensive sterilisation steps such as heat or radiation treatment. The wastewater sludge is disposed of in an environmentally friendly manner and will not undergo incineration or have to be dumped at sea or landfill.

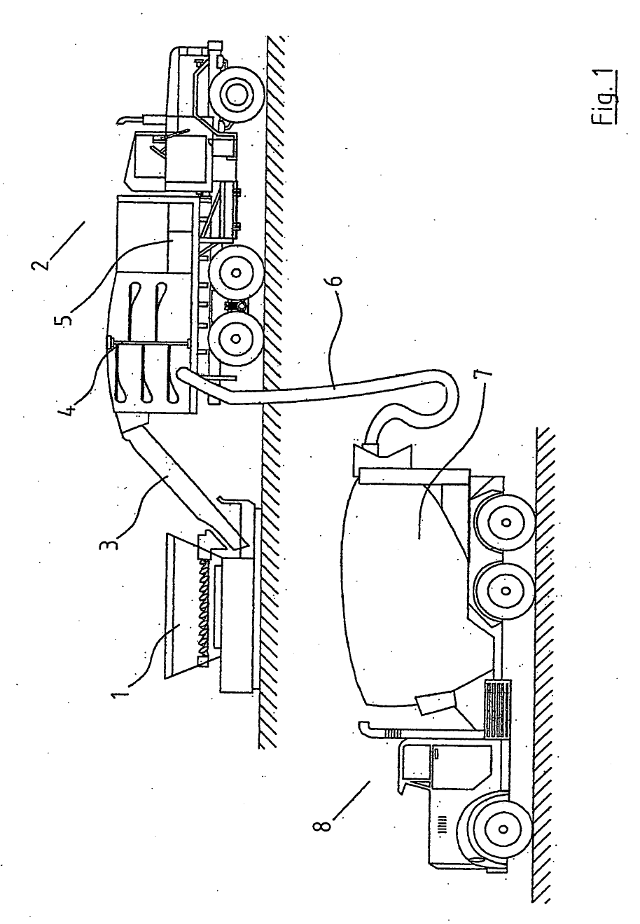

### INTRODUCTION

This invention relates to a method of using wastewater sludge in the production of concrete.

Nowadays, people are looking at finding ways of recycling their refuse in a more environmentally friendly manner. One of the main sources of pollutant is wastewater sludge which covers a variety of substances ranging from raw sewage sludge containing human or animal waste and faecal matter, to waste products created by industry. Wastewater sludge comes in many forms including wastewater sludge, sludge cake and dried sludge cake. Predominantly though, the wastewater sludge to which this invention relates is a wastewater sludge having a high water content in the region of in excess of 80% by weight of the wastewater sludge. That is, a sludge having a high proportion of water content by weight as opposed to normal household waste or the like which typically contains a high percentage, in the region of 90%, by weight of dry solids. This wastewater sludge must be disposed of in as environmentally friendly a manner as possible, whilst also being disposed of in as environmentally secure a manner as possible.

Until now, the most popular methods of disposal have been to dump wastewater sludge at sea or to send the wastewater sludge to landfill. Another popular method of disposal is to subject the wastewater to a biological process whereby the liquid and solids are separated before treating the liquids to extensive biological processes for subsequent recycling. The solids that have been separated off are usually incinerated or sent to landfill. However, these methods are becoming less viable as landfill space decreases and concern over dumping at sea increases.

Another method involves the incineration of the wastewater sludge at temperatures in excess of 1200° C. This involves the construction of expensive specially dedicated plants and has further raised concerns relating to air pollutants emitted from these plants. There is also produced a by-product from the incineration that must be disposed of by way of landfill or sea dumping.

One of the most problematic types of wastewater sludges to handle are those having a high water content by weight, as the water itself is contaminated and must be handled appropriately. The treatment of these types of wastewater sludge has heretofore included either the expensive incineration steps or the biological processes mentioned above so that the solid and liquid matter can be treated separately. Both of these are expensive particularly when dealing with such large volumes of high water content wastewater sludge such as that produced in industry. This excess water must be disposed of in an environmentally secure and friendly manner while still remaining feasible from a cost perspective. Previously, high water content wastewater sludge was pumped offshore but this practice has become more and more unacceptable.

Various attempts have been made to utilise the sludge as fertilisers and the like, although this usage is limited by governmental regulation and such use only accounts for a small percentage of the wastewater sludge produced. Before the sludge may be used as a fertiliser it must undergo composting which entails the decomposition of sewage sludge under appropriate conditions of moisture, temperature, volatile solids content and in the presence of oxygen by microorganisms. This is quite lengthy and time consuming.

Other uses of the sludge have also been proposed such as that described in British Patent No. 2,256,862 (British Gas Plc) which teaches a method of producing concrete containing sewage sludge ash which is the waste by-product subsequent to incineration of the sewage. This sewage sludge ash is used as a substitute for more expensive aggregates and is found to have good bonding characteristics. However, this involves the expensive incineration step to produce the sewage sludge ash which further increases the total cost of producing the concrete and disposing of the wastewater sludge.

U.S. Pat. No. 3,801,358 describes a method of making concrete using raw sewage and refuse. Once the concrete has cured, it is impregnated with a monomer and then heated or subjected to radiation to cause polymerisation. This will help to waterproof the concrete as well as improving sterilisation of the concrete. In order to facilitate impregnation of the monomer, the concrete block is placed in a vacuum and thereafter the concrete block is allowed to soak in the monomer for a period of time. This is a complex process that requires expensive equipment to produce the concrete blocks. Furthermore, each concrete block takes a significant period of time to make.

WO 90/15205 also describes a building element in which the main constituents comprise cement, waste sludge and fibre ingredients such as woodchip. In order to avoid direct contact with the building element, it is advised that the blocks should be plastered both inside and out in order to stabilise a structure built with these building elements, regular concrete must be poured into the blocks cavity, the strength of the building element being relatively moderate. The applicant describes how the blocks are subjected to compression for a treatment period of 24 hours. Again, these blocks will take a significant period of time to make and require coating with a plaster to render the blocks suitable for contact.

French Patent No. FR 7338465 describes a method of producing construction elements from household waste, agricultural waste or forestry waste. The waste is subjected to extensive preliminary treatments including dehydration, fragmentation and crushing until a rather coarse aggregate supplement having a particle size of in the region of 3-4 cm is produced. This dry solid material is then mixed with quicklime in order to quickly decay any organic or vegetation material present in the waste. Further aggregate, cement and water are added to the waste material before the mixture is press moulded to form the construction material. The problem with this type of method is that extensive pre-conditioning steps such as mixing and grinding must be carried out prior to the production of the building element which are both expensive and time consuming to carry out furthermore, the waste is household waste which is predominantly solids to start off with and therefore the problems associated with having to treat predominantly liquid wastewater sludge are not encountered. Due to the fact that the basic material used in the production of the construction element are particles 3-4 cm in size, the strength of the construction element may be compromised and a further expensive compression moulding step must be carried out to form the construction element which is highly disadvantageous. This patent does not suggest how industrial and other types of wastewater sludges having a high water content may be handled.

Heretofore, there has not been provided a method of using wastewater sludge in [symbol] production of concrete that will provide a concrete that is ready to use that will [symbol] require covering the concrete with plaster or subjecting the concrete to radiation other such treatment in order to render the concrete sufficiently sterile to u [symbol] Furthermore, there has not yet been provided a method that can handle predomina [symbol] liquid wastewater sludge in a safe and effective manner that is still cost effective carry out, the method not requiring significant dehydration steps prior to the product of the construction element and thereafter requiring further moulding or post mix treatments.

It is an object, therefore, of the present invention to provide a method of us wastewater sludge in the production of concrete that overcomes at least some of problems mentioned above and that is inexpensive and satisfies the environment requirements for disposal of wastewater sludge. It is a further object of the invention provide a method of using wastewater sludge, and in particular wastewater sludge having a high water content, in the production of concrete that requires the absol [symbol] minimum number of treatment steps and does not require any expensive dehydra [symbol] of the wastewater prior to commencement of the method.

### STATEMENTS OF INVENTION

According to the invention, there is provided a method of using wastewater sludge the production of concrete comprising mixing cement, aggregate and wastewater sludge to form a concrete mix characterised in that:
the additional step is carried out of mixing the wastewater sludge [symbol] an alkaline solution to achieve a wastewater sludge and alka [symbol] solution mixture having a pH equal to or in excess of 11.5, prior mixing with the aggregate and the cement.

By using this method, the invention obviates the need for expensive incineration st [symbol] or further pre-treatment steps and utilises untreated raw wastewater sludge in concrete. The concrete can then be used as a building product and thus avoids need for having to send the wastewater sludge to landfill. Furthermore, by adding an alkaline solution to the wastewater sludge, there is no need to provide further sterilisation steps such as subjecting the concrete to heating or radiation. The concrete provided will furthermore not have to be covered in plaster to render it safe. By premixing the wastewater sludge with an alkaline solution to form a wastewater sludge and alkaline solution mixture prior to mixing with the aggregate and the cement, the alkaline solution is put to best effect to act on the wastewater sludge and neutralises the harmful substances contained therein. This enhances the efficiency of the alkaline solution which is therefore required in lesser amounts. By achieving a wastewater sludge and alkaline solution mixture having a pH equal to or in excess of 11.5 a very high degree of sterilisation is achieved sufficient to render the wastewater sludge acceptable for use in the production of concrete. Therefore, both an environmentally friendly and economically efficient method is provided.

Essentially there is provide a very simple invention. The previously known methods of using wastewater sludge in the production of concrete have required elaborate, and often relatively expensive processes to render the concrete suitable for use. The problem of providing a concrete that is ready to use that will not pose a contamination risk is solved by the invention described above. Furthermore, the problem of having to provide expensive machinery and lengthy sanitising steps are obviated by the solution provided.

In one embodiment of the invention, the alkaline solution is a concrete hardener. It has been found that a concrete hardener may act as the alkaline solution and kill bacteria present in the concrete mixture. Furthermore, the concrete hardener will help to harden the concrete mixture in due course and will not have a detrimental effect on the quality of the concrete produced.

In another embodiment of the invention, the alkaline solution has a pH of between 12.5 and 14. Preferably, the alkaline solution has a pH of between 13.5 and 14. This will help to raise the pH level of the concrete mixture produced and will further improve the kill of bacteria in the wastewater sludge. The bacteria will be killed off in a very short period of time, thereby obviating the need for extensive storage times and further sterilisation techniques.

In a further embodiment of the invention, a bonding agent is added to the concrete mix. By adding a bonding agent to the concrete, there will be provided better adhesion of the component particles in the concrete. Preferably, the bonding agent used is carboxylated styrene butadiene alkali and will have a pH level in the region of 8 and 11. This will further help to improve the pH level of the concrete mixture.

In one embodiment of the invention, the wastewater sludge is in the form of dry sludge cake and water is added to the dry sludge cake, prior to the mixing of the sludge with the cement and the aggregate. By adding water to the wastewater sludge, the correct amount of water will be present to produce a uniform concrete each time, thereby ensuring good quality concrete each time. Preferably, sufficient water is added to the wastewater sludge to bring the water content of the diluted wastewater sludge to 80%. or more water by weight.

In another embodiment of the invention, a polymer is added to the wastewater sludge. The polymer will further act as a bonding agent to the concrete providing improved adhesion properties to the concrete's components.

In a further embodiment of the invention, the concrete is stored for between 28 days and 6 months. By storing the concrete for a sufficient period of time, the concrete will be able to set which will further ensure that all bacteria are killed off and that the concrete adheres to health and safety standards.

In one embodiment of the invention, the aggregate comprises one or more of grey wacke stone, sand, sandstone, gravel, limestone, crushed shale, crushed seashells, pencil, kiln dried sand, grit, pulverised fuel ash, slag from steelworks, quicklime and recycled crushed concrete. Preferably, the aggregate will comprise limestone which is seen as particularly useful to produce a robust, strong concrete. The limestone furthermore has a suitable pH value to further sterilise the wastewater sludge when being used in the production of concrete.

In a further embodiment of the invention there is provided a method of using wastewater sludge in the production of concrete in which additional cement is used instead of aggregate in the concrete mixture. This may in some instances be more economical than providing further aggregates whilst also providing a useable concrete mixture that contains a high content of wastewater sludge.

In another embodiment of the invention, a detergent is added to the concrete mix prior to curing. By providing the detergent, further bacterial kill may be achieved, again providing a concrete suitable for use in goods and products that conform to health and safety standards.

In a further embodiment of the invention, the alkali solution added to the wastewater sludge is Sika [Registered Trade Mark™]. This is seen as particularly useful as Sika is both in inexpensive and effective in its function. The active ingredients of the strong alkali preferably include one or more of using potassium hydroxide, sodium aluminate and potassium carbonate. Alternatively, instead of using Potassium Hydroxide to stabilise and sterilise the wastewater sludge, Sodium Hydroxide, Calcium Hydroxide or Barium Hydroxide could be used. It is envisaged that the alkali solution could comprise an electrically charged (ionised) water/salt solution.

In one embodiment of the invention, the alkali solution is added to the wastewater sludge in the ratio of between1:200 and 5:200 parts alkali solution to parts wastewater sludge. Preferably, the alkali solution is added to the wastewater sludge in the ratio of 3:200. These amounts are sufficient to see good bacterial kill in the final concrete mixture.

In another embodiment of the invention, the wastewater sludge, cement and aggregate are mixed in a ratio of 1:1:6 by weight to form the concrete mix. This is seen as a particularly efficient mix and will provide a robust concrete product suitable for most uses.

In a further embodiment of the invention, the blended concrete mix is sealed in a heavy duty plastic container. This will further prevent any leaching of the concrete and will minimise the risk of contamination to the environment from any harmful products remaining in the wastewater sludge and the concrete.

In one embodiment of the invention, there is provided a concrete product made in accordance with the method as described above. By having such a product, an inexpensive concrete product is provided, while also providing an alternative way of disposing of the wastewater sludge in a more environmentally friendly and cost efficient manner.

In another embodiment of the invention, the wastewater sludge comprises between 8% and 55% of the concrete mixture. In one embodiment the wastewater sludge comprises between 8% and40% of the concrete mixture. In a further embodiment the

wastewater sludge comprises between 8% and 25% of the concrete mixture. Alternatively, the waster sludge fnay comprise between 11% and 14% of the concrete mixture. Preferably, the wastewater sludge will comprise 12% by weight of the concrete mbcture. This allows for a large quantity of wastewater sludge to be incorporated into the concrete, while stir maintaining all the strength properties necessary forthe concrete to be used in construction.

In another embodiment of the invention there is provided a method of using wastewater sludge in the production of concrete in which the percentage of liquid content of the wastewater sludge is between 50% and 97° h and the percentage of solid matter in the wastewater sludge is between 3% and 50%. In this way a large amount of the liquid required for the manufacture of the concrete may be taken from the Wastewater sludge. This is a useful way of using up the water content of the wastewater sludge and avoiding alternative expensive techniques to remove the water from the sludge. Preferably the percentage of liquid content in the sludge is between 80 and 97%.

In a further embodiment of the invention there is provided a method of using wastewater sludge in the production of concrete in which the alkaline solution is mixed with the wastewater sludge so that a wastewater sludge and alkaline solution mixture having a pH equal to or greater than 12 is achieved. In one embodiment, sufficient alkaline solution is added to achieve a wastewater sludge and alkaline solution mixture having a pH equal to or in excess of 12.5. This will ensure that a sufficient degree of the hazardous materials contained in the wastewater sludge will be neutralised prior to the concrete mixture being formed. These hazardous materials can be neutralised in a quick and efficient manner that can be accurately estimated.

### DETAILED DESCRIPTION OF THE INVENTION

The invention will now be more clearly understood from the following description of some embodiments thereof, given by way of example only, with reference to the accompanying in which there is shown a diagrammatic illustration of one form of suitable apparatus that may be used for carrying out the method of the invention.

Wastewater sludge is fed from a container 1 to a mixing truck 2 by way of a conveyor 3. The conveyor 3 has load cells (not shown) connected thereto to carefully monitor the amount of wastepaper being delivered to the mixing truck 2. The wastewater is placed in a paddle mixer 4 of the mixing truck 2 wherein it is blended with an alkali solution. Once the wastewater and alkali solution have been mixed sufficiently, a pump 5 on the mixing truck 2 is actuated to pump the wastewater and alkali mixture through a flexible hose pipe 6 to a mixing drum 7 of a nearby concrete mixing truck 8. The mixing drum 7 has already contained therein a thoroughly blended mixture of cement and aggregate. Once the alkali solution and the wastewater have been added to the mixing drum 7 containing the aggregate and cement, the mixing drum 7 is rotated, thereby blending the materials contained therein to form a concrete mixture.

The relative amounts of wastewater sludge, cement and aggregate are determined, depending on the strength and curing time requirements of the individual producing the concrete. The alkali solution blended with the wastewater sludge can be a concrete hardener such as that sold under the brand name Sika™. The alkali will further act as a hardener assisting in the curing time of the concrete mix once the wastewater sludge and the dry mix have been blended together. The wastewater sludge will be stabilised in that heavy elements such as phosphorus are physically stabilised within the matrix of the concrete and the sludge will also be sterilised in that the bacteria, viruses or other ling organisms normally present in the sludge will be killed.

In addition to the strong alkali, a bonding agent such as those sold under the Registered Trade Marks EVOSTICK, RONAFIX, or Polyvinyl Acetate are further added to the wastewater sludge to improve the pH value of the concrete to be produced, whilst also improving the bonding properties of each of the main components of the concrete. This concrete mix may then be used to construct road side barriers, concrete verges, and the like.

A liquid detergent such as those produced by JEYES™, DETTOL™ or FLASH™ is added to the unsolidified concrete mix to further eliminate any residual bacteria present in the wastewater sludge. The liquid detergent may be added to the concrete mix regardless of whether the alkali substances have been added. The concrete may then be poured into a heavy duty plastic container and sealed therein to avoid any risk of contamination to the environment by teaching of the concrete once it has been exposed to the elements.

Some examples of a concrete mixture produced in-accordance with the invention will now be given.

### EXAMPLE 1

1 Kg of wastewater sludge is mixed with 0.3 Kg of bonding agent in a suitable container. Once the bonding agent and wastewater sludge have been sufficiently mixed together, 0.3 Kg of concrete hardener is added to the mixture and stirred in thoroughly to assist in the hardening process, as well as killing any bacteria present in the mixture. Separately, 6 Kg of aggregate is mixed with 1 Kg of cement to form a dry mix. This dry mix is then mixed with the wastewater sludge, hardening agent and bonding agent and blended together until a concrete mixture is formed. This concrete mixture may then be used for road construction or other suitable purpose.

A sample of concrete made in accordance with the above example provided the following toxicity results for the main heavy metal contamination types, as shown in Table 1 below.

TABLE 1

| | Max. Value in | Max. Value in | Value Leached | |
|---|---|---|---|---|
| Parameter | Sludge | Soil | from Concrete | |
| Cadmium | 20 | 1 | 0.176 | mg/Kg |
| Copper | 1000 | 50 | 0.846 | mg/Kg |
| Nickel | 300 | 30 | 0.96 | mg/Kg |
| Lead | 750 | 50 | 0.18 | mg/Kg |
| Zinc | 2500 | 150 | 0.95 | mg/Kg |
| Mercury | 16 | 1 | <0.025 | mg/Kg |
| Chromium | | 3.5 kg/ha/yr | 1.66 | mg/Kg |

Furthermore, various cube strength tests on random samples of the concrete were taken after hardening for 28 days. The measured strengths ranged from 3.0 to 6.0 N/mm² with an average of 4.5 N/mm². It will be understood that by having more concrete contained within the mix, the average cube strength test results of 7 or 8 N/mm² were attainable. This provides an aggregate impact value of less than 25% which is sufficient for use as heavy duty concrete floor finishes in most jurisdictions. Furthermore, the 10% fines value in excess of 130 KN is also easily attainable with careful selection of aggregate.

### EXAMPLE 2

Five litres of Sodium Aluminate, five litres of Potassium Hydroxide and five litres of Potassium Carbonate are mixed together in a suitable mixing vessel. One ton of sludge cake at 15 to 20% dry solids is added to the mixed Sodium Aluminate, Potassium Hydroxide and Potassium Carbonate solution and blended with some aggregate until a viscous liquid is formed. Five litres of bonding agent and 5 to 10 litres of water are then added to the viscous liquid. Separately, six tons of aggregate is mixed with one ton of cement to form a dry mix that has the aggregate and cement evenly mixed throughout The blended mixture containing the sludge cake is then added to the dry mix for a period of between five to ten minutes to form a concrete mixture. The concrete mixture is then ready to be poured. Similar toxicity results for the main heavy metal contamination types as shown for the previous example in Table 1 were achieved for the concrete mixture of Example 2.

It is envisaged that the mixing of the cement and aggregate could be performed in a standard concrete mixing truck or other such similar device. The sewage sludge could be added to the dry mix once any additional hardening agents or bonding agents had been thoroughly mixed in with the sewage sludge. The hardening and bonding agents could be pre-mixed with the sewage sludge in a separate mixing vessel before being pumped into the concrete mixing truck with the dry mix it is envisaged that the hardening and bonding agents are mixed with the sewage sludge at between 500 and 1000 revolutions per minute to thoroughly mix the components together. Additional water may be added to the sewage sludge, if necessary, prior to mixing with any hardening or bonding agents.

It will be understood the aggregates used could be any one from a selection of crushed grey wacke stone, kiln dried sand, normal sand, limestone, gravel, grit, crushed sandstone, crushed pencil, crushed shale, crushed seashells, crushed concrete, pulverised fuel ash, quicklime or any other suitable type of stone. Slag from steel processing which is the silicate waste from steel blast furnaces could also be used as one alternative aggregate material. Reinforcing materials such as glass fibre or steel can also be added as part of the aggregate to further strengthen the concrete. The aggregates used will largely depend on the desired characteristics of the concrete to be produced. The concrete produced in accordance with the invention may itself be crushed subsequent to setting and thereafter may be used as a fill material for road surfaces.

The blended concrete mix could also be sealed in a heavy duty plastic container to prevent any risk of harmful materials being leached out of the concrete. As an alternative to a heavy duty plastic container a fibreglass coating or plastic coating may be applied to concrete produced in accordance with the method to add further protection and additional strength to the concrete.

In this specification, the term “hardening agent” has been used to define a substance that will reduce the time necessary for the concrete mixture to set. A concrete bonding agent is used to describe a substance that is used to enhance the cohesion of the individual ingredients, once mixed. In the examples described above it will be understood that various ingredients in the hardening agent act as stabilising and sanitizing components whereas various other ingredients act as hardening components. Potassium Carbonate or Aluminium Silicate would act as hardening components whereas Potassium Hydroxide would act as a stabilising and sanitising component. Other alkalines that could be substituted for the Potassium Hydroxide include Sodium Hydroxide, Calcium Hydroxide or Barium Hydroxide or other similar substances.

In this specification the terms “comprise, comprises, comprised and comprising” as well as the terms “include, includes, included and including” are deemed totally interchangeable and should be afforded the widest possible interpretation.

The invention is in no way limited to the embodiment hereinbefore described, but may be varied in both construction and detail within the scope of the claims.

1-30. (canceled)

31. A method of using wastewater sludge in the production of concrete comprising mixing cement, aggregate and wastewater sludge to form a concrete mix characterised in that:
the additional step is carried out of mixing the wastewater sludge with an alkaline solution to achieve a wastewater sludge and alkaline solution mixture having a pH equal to or in excess of 11.5, prior to mixing with the aggregate and the cement.

32. A method of using wastewater sludge in the production of concrete as claimed in claim 31, in which the alkaline solution is a concrete hardener.

33. A method of using wastewater sludge in the production of concrete as claimed in claim 31, in which the alkaline solution has a pH of between 12.5 and 14.

34. A method of using wastewater sludge in the production of concrete as claimed in claim 33, in which the alkaline solution has a pH of between 13.5 and 14.

35. A method of using wastewater sludge in the production of concrete as claimed in claim 31, in which a bonding agent is added to the concrete mix.

36. A method of using wastewater sludge in the production of concrete as claimed in claim 35, in which the bonding agent is carboxylated styrene butadlene alkali.

37. A method of using wastewater sludge in the production of concrete as claimed in claim 35, in which the bonding agent has a pH level of between 8 and 11.

38. A method of using wastewater sludge in the production of concrete as claimed in claim 31, in which the wastewater sludge is in the form of dry sludge cake and water is added to the dry sludge cake, prior to the mixing of the sludge with the cement and the aggregate.

39. A method of using wastewater sludge in the production of concrete as claimed in claim 31, in which a polymer is added to the wastewater sludge.

40. A method of using wastewater sludge in the production of concrete as claimed in claim 31, in which the concrete is stored for between 28 days and 6 months.

41. A method of using wastewater sludge in the production of concrete as claimed in claim 31, in which the aggregate comprises one or more of wacke stone, sand, sandstone, gravel, limestone, crushed shale, crushed seashells, pencil, quarried, kiln dried sand, grit, pulverised fuel ash, quicklime and recycled crushed concrete.

42. A method of using wastewater sludge in the production of concrete as claimed in claim 31, in which the aggregate comprises limestone.

43. A method of using wastewater sludge in the production of concrete as claimed in claim 31, in which additional cement is used instead of aggregate in the concrete mixture.

44. A method of using wastewater sludge in the production of concrete as claimed in claim 31, in which a detergent is added to the concrete mix prior to curing.

45. A method of using wastewater sludge in the production of concrete as claimed in claim 31, in which the alkali solution added to the wastewater sludge is Sika.

46. A method of using wastewater sludge in the production of concrete as claimed in claim 31, in which the alkali solution comprises a electrically charged (ionised) water/salt solution.

47. A method of using wastewater sludge in the production of concrete as claimed in claim 31, in which the alkali solution is added to the wastewater sludge in the ratio of between 1:200 and 5:200 parts alkali solution to parts wastewater sludge.

48. A method of using wastewater sludge in the production of concrete as claimed in claim 47, in which the alkali solution is added to the wastewater sludge in the ratio of 3:200.

49. A method of using wastewater sludge in the production of concrete as claimed in claim 31, in which the wastewater sludge, cement and aggregate are mixed in a ratio of 1:1:6 by weight to form the concrete mix.

50. A method of using wastewater sludge in the production of concrete as claimed in claim 31, in which the blended concrete mix is sealed in a heavy duty plastic container.

51. A method of using wastewater sludge in the production of concrete as claimed in claim 31, in which the wastewater sludge comprises between 8% and 55% of the concrete mixture.

52. A method of using wastewater sludge in the production of concrete as claimed in claim 51 in which the wastewater sludge comprises between 8% and 40% of the concrete mixture.

53. A method of using wastewater sludge in the production of concrete as claimed in claim 51 in which the wastewater sludge comprises between 8% and 25% of the concrete mixture.

54. A method of using wastewater sludge in the production of concrete as claimed in claim 51, in which the wastewater sludge comprises between 11% and 14% of the concrete mixture.

55. A method of using wastewater sludge in the production of concrete as claimed in claim 51, in which the wastewater sludge comprises 12% of the concrete mixture.

56. A method of using wastewater sludge in the production of concrete as claimed in claim 31, in which the percentage of liquid content of the wastewater sludge is between 50% and 97% and the percentage of solid matter in the wastewater sludge is between 3% and 50%.

57. A method of using wastewater sludge in the production of concrete as claimed in claim 56 in which the percentage of liquid content of the wastewater sludge is between 80% and 97%.

58. A method of using wastewater sludge in the production of concrete as claimed in claim 31, in which the wastewater sludge and alkaline solution mixture has a pH equal to or in excess of 12.

59. A method of using wastewater sludge in the production of concrete as claimed in claim 31, in which the wastewater sludge and alkaline solution has a pH equal to or in excess of 12.5.

60. A concrete product made in accordance with the method steps of claim 31.
